(19) United States
(12) Patent Application Publication
(10) Pub. No.: US 2012/0161459 A1
(43) Pub. Date: Jun. 28, 2012

(54) Product Gripper

(75) Inventor: Guenther Weber, Gross Nemerow (DE)

(73) Assignee: Weber Maschinenbau GmbH Breidenbach, Breidenbach (DE)

(21) Appl. No.: 13/379,629

(22) PCT Filed: May 19, 2010
(86) PCT No.: PCT/EP2010/003076

§ 371 Date: Mar. 12, 2012

(30) Foreign Application Priority Data
Jun. 23, 2009 (DE) 10 2009 030 011.2

(51) Int. Cl. B66C 1/58

(52) U.S. Cl. 294/106; 294/86.4

(57) ABSTRACT

The invention relates to a product gripper for picking up a product, having two shovels (22) and a driving means (26) for moving the shovels (22) between a first position, in which the shovels (22) can be placed onto a support for the product to be picked up, on opposite sides of the product to be picked up, and a second position, in which the shovels (22) are located at least partially under the product to be picked up. The product gripper is furthermore provided with means (32) for shortening the product.

The invention relates to a product gripper for picking up a product which has two spade blades and a driving means to move the spade blades between a first position in which the spade blades can be placed onto a support for the product to be picked up at oppositely disposed sides of the product to be picked up and a second position in which the spade blades are located at least party beneath the product to be picked up.

Product grippers of this type are generally known and are used, for example, in the food industry to transfer food products from a first conveying means to a second conveying means, to sort them or to introduce them into a packaging. The product grippers are typically mounted at the moving part of a robot.

The products to be picked up can be individual pieces or slices of, for example, meat, sausage, cheese and the like or portions which are composed of a plurality of such pieces or slices. With a portion comprising a plurality of slices, the individual slices can be folded once or a multiple of times and can optionally at least partly lie over one another. Such portions comprising a plurality of folded slices are usually pushed together by hand, i.e. are shortened with respect to their lengths, so that they can be placed into shorter packagings.

It is the underlying object of the invention to provide a product gripper which simplifies the product handling.

The invention is satisfied by a product gripper having the features of claim 1 and in particular in that the product gripper includes means for shortening the product in at least one direction.

In accordance with the invention, the product gripper therefore satisfies a double function in that it also takes over the task of shortening or pushing together the product in addition to its original task of gripping a product. Since the product gripper in accordance with the invention does not only grip the product to be handled, for example a portion of a plurality of folded slices, but also compresses it, the product to be handled no longer has to be pushed together by hand. Instead, the product gripper can directly place the picked up and simultaneously shortened product into a correspondingly provided packaging. As a result, a manual workstep can therefore be saved by the product gripper in accordance with the invention, whereby the product handling or the product processing overall not only becomes more hygienic, but also simpler and more automated and thus ultimately less expensive.

Advantageous embodiments of the invention can be seen from the dependent claims, from the description and from the drawing.

It is generally conceivable to form the means for shortening the product so that the product is pushed together in more than one direction, for example it two directions at right angles to one another. A particularly simple construction embodiment can be realized when the shortening means are formed such that they only push the product together viewed in the direction of movement of the spade blades.

In accordance with a preferred embodiment, the shortening means are arranged between the spade blades. The shortening means are therefore components which are separate from the spade blades and which can be actuated in dependence on or independently of the movement of the spade blades.

Alternatively to this, however, an embodiment is also conceivable in which a product to be picked up is pushed together by the spade blades themselves or by holders for the spade blades. In this case, the shortening of the product is therefore at least coupled to the movement of the spade blades.

To prevent the shortening means from unintentionally coming into engagement with a product on the picking up thereof, it is advantageous if the shortening means are adjustable between a position of rest in which they are spaced apart from a product to be picked up and an active position in which they are in engagement with a product to be picked up and shorten it.

For example, the shortening means can include two mutually spaced apart flaps which are each pivotable about a pivot axis between a first, at least approximately horizontal position (position of rest) and a second, substantially vertical position (active position), said pivot axis being substantially orientated at a right angle to the direction of movement of the spade blades.

Alternatively, however, an embodiment is also conceivable in which the shortening means include two mutually spaced apart sliders, in particular vertically oriented sliders, which are displaceable between a first position (position of rest) in which they have a larger spacing from one another and a second position (active position) in which they have a smaller spacing from one another.

In accordance with a preferred embodiment, a mechanism is provided by which the movement of the spade blades from their first position into their second position can be converted into an adjustment of the shortening means from their position of rest into their active position. The adjustment of the shortening means by the mechanism is therefore coupled to the movement of the spade blades so that no separate drive for the adjustment of the shortening means has to be provided.

In accordance with a particularly simple construction embodiment, the mechanism includes rollers connected to the spade blades and sloped surfaces formed at the shortening means on which the rollers can run. This mechanism is in particular suitable for the adjustment of shortening means including flaps.

Locking means are advantageously provided for locking the shortening means in their position of rest and/or in their active position. The locking means can include magnets, for example.

In accordance with a further embodiment, a stamp is provided for pressing down a picked-up product at a placement location. The stamp can, for example, serve to press down a picked-up product into a packaging.

The stamp is preferably movable between a raised position in which a lower side of the stamp facing the picked-up product is spaced apart from the product and a lowered position in which the lower side of the stamp lies approximately at the level of a spade blade plane defined by the spade blades or beneath said plane. The stroke of the stamp can in other words be larger than the maximum thickness of a product to be picked up so that a product to be placed down can be effectively pressed down into a packaging arranged beneath the spade blade plane.

The stamp is advantageously arranged between the shortening means. In this respect, the extent of the stamp viewed in the direction of movement of the spade blades preferably substantially corresponds to the spacing of the shortening means in their active position. In other words, the shortening means form a passage in which the compressed product lies and over whose substantially total width the stamp acts on the compressed product, whereby a product to be placed down can be controlled and can be pressed into a packaging with a uniform pressure distribution.

As already mentioned, locking means can be provided for locking the shortening means in their active position. It is ensured by the shortening means locked in their active position that a picked-up product maintains its shortened total length on its release.

To be able to release the shortening means from their active position, the product gripper preferably includes a corresponding release mechanism. The release mechanism can include magnets which are provided at the stamp and at the shortening means and which are arranged and poled so that the magnets of the stamp and the magnets of the shortening means repel one another when the stamp reaches its lowered position. The release of the shortening means from their active position takes place automatically in this manner on the placing down of a picked-up product, in particular when the product to be placed down is pressed completely into its packaging.

Whereas the shortening means are brought from their position of rest into their active position by the moving together of the spade blades in accordance with an advantageous embodiment, the reverse process, i.e. the adjustment of the shortening means from their active position into their position of rest, is therefore independent of the movement of the spade blades and is instead coupled to the reaching of the lowered position by the stamp.

The invention will be described in the following purely by way of example with reference to an advantageous embodiment and to the enclosed drawing. There are shown:

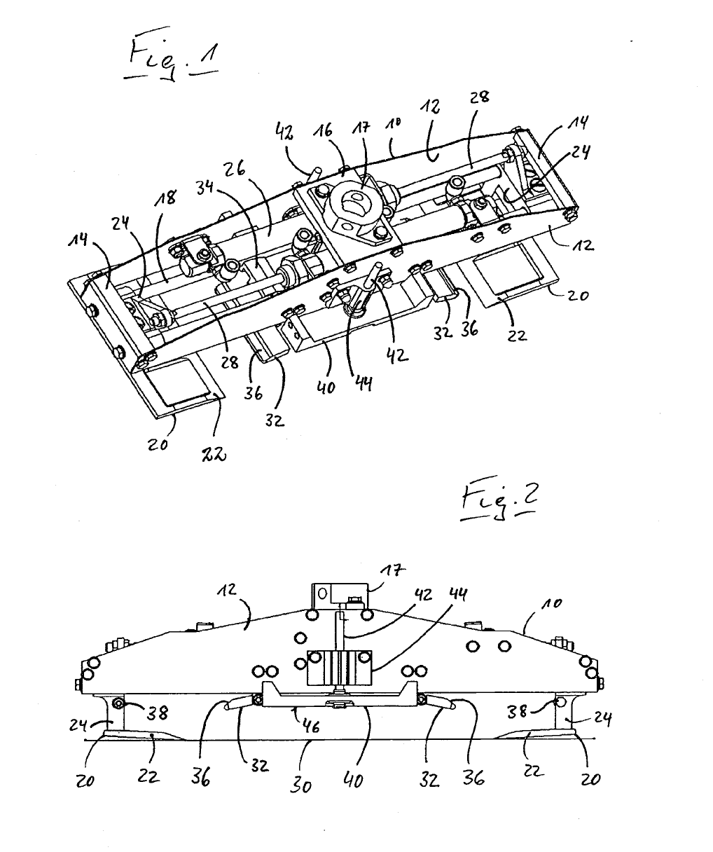

FIG. 1 a perspective view of a product gripper in accordance with the invention with open spades, from above;

FIG. 2 a side view of the product gripper of FIG. 1;

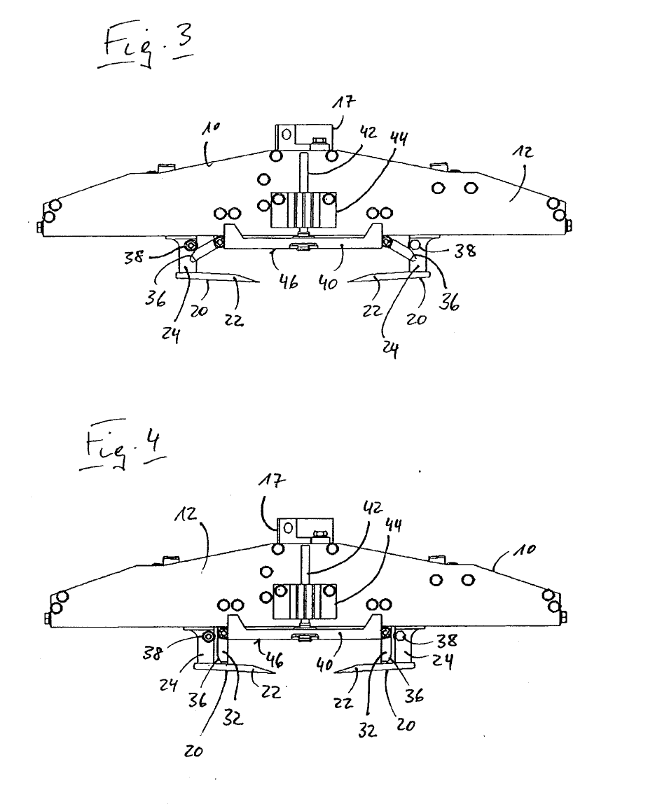

FIG. 3 a side view of the product gripper of FIG. 1 with half-closed spades;

FIG. 4 a side view of the product gripper of FIG. 1 with fully closed spades;

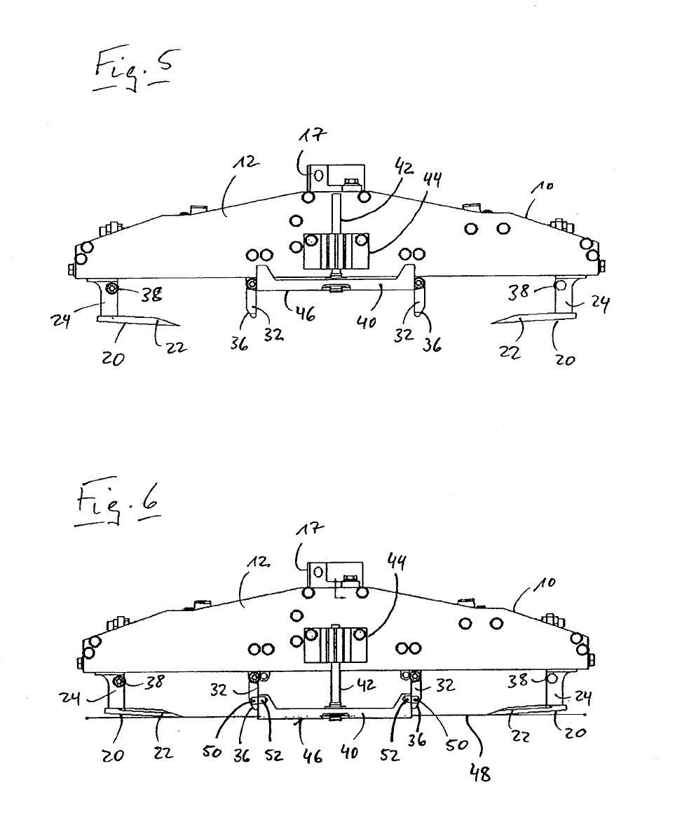

FIG. 5 a side view of the product gripper of FIG. 1 with open spades and folded-down shortening means; and

FIG. 6 a side view of the product gripper of FIG. 1 with open spades and lowered stamp.

The product gripper shown in the Figures has a frame structure 10 which includes two mutually spaced apart metal side plates 12 which extend substantially in parallel to one another and which are connected to one another in the region of their outer ends by two transverse rails 14 and in a middle upper region by a transverse web 16. An adapter 17 which enables the mounting of the product gripper to a robot arm is attached to the transverse web 16.

Two guide rods 18 which extend spaced apart from one another and parallel to the metal side plates 12 are fastened to the transverse rails 14. The guide rods 18 serve for the guidance of two spades 20.

Each spade 20 includes a spade blade 22 which is displaceably supported at the guide rods 18 by means of a spade blade holder 24.

To displace the spades 20 along the guide rods 18, each spade 20 has an actuation cylinder 26 associated with it which is, for example, pneumatically or hydraulically actuable, which is arranged above the guide rods 18 and which has a piston 28 which is movable in parallel to the guide rods 18 and which is connected in the region of its free end to the associated spade blade holders 24. The actuation cylinders 26 are carried by the frame structure 10.

It is understood that only one actuation cylinder or one electric drive can generally also be provided for displacing the spades 20.

The spades 20 can be moved with the aid of the actuation cylinders 26 between a first position in which the spade blades 22 have a maximum spacing from one another and which can be placed onto a support 30 for the product to be picked up, for example a portion of folded slices of sausage, ham or cheese, at opposite sides of a product to be picked up (FIG. 2) and a second position in which the spades 20 have a minimal distance from one another and the spade blades 22 are at least partly located beneath the product to be picked up (FIG. 4).

To shorten the length of a product to be picked up viewed in the direction of movement of the spades 20, i.e. to compress the product to be picked up in said direction, two flaps 32 arranged between the spades 20 are pivotably supported at the frame structure 10, more precisely at respective cross members 34 which extend between the metal side plates 12 and are fastened thereto, with the corresponding pivot axes extending at right angles to the guide rods 18 and thus to the direction of movement of the spades 20.

The flaps are each pivotable between a first, approximately horizontal position (FIG. 2) and a second substantially vertical position (FIG. 4). To lock the flaps 32 in their first and second positions, magnets are let into the flaps 32 and cooperate in an attracting manner with magnets correspondingly let into the cross members 34.

The flaps 32 have sloped surfaces 36 at the spade side in the region of their free ends. Rollers 38 oriented transversely to the direction of movement of the spades 20 are arranged at the spade blades 24 such that the rollers 38 run onto the sloped surfaces 36 of the flaps 32 located in their first position (FIG. 3) on the moving together of the spades 20 and hereby bring the flaps 32 into their second position (FIG. 4).

The length of the flaps 32 is selected so that the free ends of the flaps 32 reach at least approximately up to the spade blades 22 in the second position of the flaps 32. On their pivoting into the second position, the flaps 32 consequently move into engagement with the product to be picked up and push it together, whereby the length of the product is shortened viewed in the direction of movement of the spades 20. The width of the flaps 32, i.e. their dimensions viewed transversely to the direction of movement of the spades 20, at least approximately corresponds to the width of the spade blades 22.

A stamp 40 is arranged between the flaps 32 and extends with flaps 32 located in their second position substantially over the total spacing between the flaps 32. The width of the stamp 40 likewise at least approximately corresponds to the width of the spade blades 22.

The stamp 40 can be moved between a raised position (FIGS. 1 to 5) and a lowered position (FIG. 6) by means of a cylinder, not shown in the Figures, which can be pneumatically or hydraulically actuated, for example. In this respect, the stamp 40 is guided with the aid of guide bars 42 which are attached to said stamp, which extend substantially at right angles to the guide rods 18 and which extend through guide elements 44 attached to the outer sides of the metal side plates 12.

The stroke of the stamp 40 is selected so that a lower side 46 of the stamp 40 facing the spade blades 22 is spaced apart from the upper side of a picked-up product in the raised state of the stamp 40, whereas the lower side 46 of the stamp lies somewhat lower than a spade blade plane 48 defined by the spade blades 22 in the lowered state of the stamp 40.

As is shown in FIG. 6, magnets 50 are let in at the stamp side in the region of the free ends of the flaps 32. Magnets 52 are likewise let into the stamp 40 at the flap side, said magnets having the same polarity as the magnets 50 of the flaps 32 and being arranged such that they move into the region of the magnets 50 of the flaps 32 with a fully lowered stamp 40.

Due to their same polarity, the magnets 52 of the stamp 40 and the magnets 50 of the flaps 32 repel one another, whereby the flaps 32 are released from the second position and—optionally supported by spring force—flip back into their first position.

The operation of the product gripper will be explained in the following:

Starting from the open state of the product gripper in which the spades 20 are located in their first position, i.e. that is have a maximum spacing from one another, the product gripper is lowered onto a product to be picked up until the spade blades 22 are seated on the product support 30 at oppositely disposed sides of the product (FIG. 2).

The spade blades 22 are now moved toward one another and pushed beneath the product to be picked up by a corresponding actuation of the actuation cylinders 26. In this respect, the rollers 38 of the spades 20 run onto the sloped surfaces 36 of the flaps 32, whereby the flaps 32 are flipped down, i.e. are pivoted into their vertical second position, and in so doing push the product to be picked up together in the direction of movement of the spades 20, i.e. that is shorten its length (FIGS. 3 and 4).

In this state of the product gripper, the picked-up product is transported from its pick-up location to a placement location. In this respect, the picked-up product is fixed by the vertically set flaps 32 so that it cannot slip off the spade blades 22.

The product gripper is lowered at the placement location and the spades 20 are moved apart again, i.e. opened, by the actuation cylinder 26 (FIG. 5). The flaps 32 remain vertically set during the moving apart of the spades 20 so that the product maintains its shortened total length on its release.

Finally, the stamp 40 is moved down to press the product into a packaging (FIG. 6). As soon as the stamp 40 reaches its lowest position, the flaps 32 are released from their vertical position by the mutually repelling magnets 50, 52 and the flaps 32 pivot back into their horizontal position. The product gripper is now again located in its starting position and is ready for the picking up of a new product.

Although the Figures only show a product gripper having shortening means designed in the form of flaps 32, it must be pointed out that the shortening means in accordance with an alternative embodiment can also include two mutually spaced apart sliders, in particular vertically oriented sliders, which—e.g. guided at the frame structure 10—are displaceable between a first position (position of rest) in which they have a larger spacing from one another and a second position (active position) in which they have a smaller spacing from one another.

The movement of the sliders toward one another can in this respect be coupled to the moving together of the spade blades 22 or can be independent thereof.

When a picked-up product is placed down, the sliders preferably remain locked in their second position for so long until the stamp 40 has pressed the product into a packaging. I.e. the spade blades 22 move apart without “taking along” the sliders in so doing.

The sliders would only again move back into their first position with the subsequent upward movement of the stamp. It is conceivable in this respect that not only the locking of the sliders by the lowered stamp is released, but also that the moving apart of the sliders as a whole is coupled to the upward movement. A separate drive for the sliders can, however, naturally also be provided which enables a moving apart of the sliders independently of the stamp movement.

### REFERENCE NUMERAL LIST

10 frame structure
12 metal side plate
14 transverse rail
16 transverse web
17 adapter
18 guide rod
20 spade
22 spade blade
24 spade blade holder
26 actuation cylinder
28 piston
30 support
32 flap
34 cross member
36 sloped surface
38 roller
40 stamp
42 guide bar
44 guide element
46 lower side
48 spade blade plane
50 magnet
52 magnet

1-14. (canceled)

15. A product gripper for picking up a product, comprising
two spade blades (22) and
a drive means (26) to move the spade blades (22) between a first position, in which the spade blades (22) can be placed onto a support (22) for the product to be taken up at oppositely disposed sides of the product to be taken up, and a second position in which the spade blades (22) are located at least partly beneath the product to be taken up,
wherein means (32) for shortening the product in at least one direction are provided.

16. A product gripper in accordance with claim 15, wherein the shortening means (32) are formed so that they shorten the product viewed in the direction of movement of the spade blades (22).

17. A product gripper in accordance with claim 15, wherein the shortening means (32) are arranged between the spade blades (22).

18. A product gripper in accordance with claim 15, wherein the shortening means (32) are adjustable between a position of rest in which they are out of engagement with a product to be picked up and an active position in which they are in engagement with a picked-up product and shorten it.

19. A product gripper in accordance with claim 15, wherein the shortening means include two mutually spaced apart flaps (32) which are each pivotable about a pivot axis between a first, at least approximately horizontal position and a second, substantially vertical position, said pivot axis being substantially orientated at a right angle to the direction of movement of the spade blades (22).

20. A product gripper in accordance with claim 18, wherein a mechanism (36, 38) is provided by which the movement of the spade blades (22) from their first position into their second position can be converted into an adjustment of the shortening means (32) from their position of rest into their active position.

21. A product gripper in accordance with claim 20, wherein the mechanism includes rollers (38) connected to the spade blades (22) and sloped surfaces (36) which are formed at the shortening means (32) and onto which the rollers (38) can run.

22. A product gripper in accordance with claim 18, wherein locking means are provided for locking the shortening means (32) in their position of rest and/or in their active position.

23. A product gripper in accordance with claim 22, wherein the locking means include magnets.

24. A product gripper in accordance with claim 22, wherein a release mechanism for releasing the locking of the shortening means (32) in their active position is present.

25. A product gripper in accordance with claim 15, wherein a stamp (40) for pressing down a picked-up product at a placement location is present.

26. A product gripper in accordance with claim 25, wherein the stamp (40) is movable between a raised position in which a lower side (46) of the stamp (40) facing the picked-up product is spaced apart from the product and a lowered position in which the lower side (46) of the stamp lies approximately at the level of a spade blade plane defined by the spade blades (22) or beneath said plane.

27. A product gripper in accordance with claim 25, wherein the stamp (40) is arranged between the shortening means (32).

28. A product gripper in accordance with claim 27, wherein the extent of the stamp (40) viewed in the direction of movement of the spade blades (22) substantially corresponds to the spacing of the shortening means (32) in their active position.

29. A product gripper in accordance with claim 22, wherein a release mechanism for releasing the locking of the shortening means (32) in their active position and a stamp (40) for pressing down a picked-up product at a placement location are present.

30. A product gripper in accordance with claim 29, wherein the release mechanism includes magnets (50, 52) which are provided at the shortening means (32) and at the stamp (40) and which are arranged and poled so that the magnets (50) of the shortening means (32) and the magnets (52) of the stamp (40) repel one another when the stamp (40) reaches its lowered position.

31. A product gripper in accordance with claim 30, wherein the stamp (40) is movable between a raised position in which a lower side (46) of the stamp (40) facing the picked-up product is spaced apart from the product and a lowered position in which the lower side (46) of the stamp lies approximately at the level of a spade blade plane defined by the spade blades (22) or beneath said plane.

32. A product gripper in accordance with claim 30, wherein the stamp (40) is arranged between the shortening means (32).

33. A product gripper in accordance with claim 32, wherein the extent of the stamp (40) viewed in the direction of movement of the spade blades (22) substantially corresponds to the spacing of the shortening means (32) in their active position.
